(19) United States
(12) Patent Application Publication
(10) Pub. No.: US 2021/0056328 A1
(43) Pub. Date: Feb. 25, 2021

(54) MIRROR REPLACEMENT SYSTEM AND METHOD FOR DISPLAYING IMAGE AND/OR VIDEO DATA OF THE SURROUNDINGS OF A MOTOR VEHICLE

(71) Applicant: BCS AUTOMOTIVE INTERFACE SOLUTIONS GMBH, Radolfzell (DE)

(72) Inventors: NIKOLAJ POMYTKIN, Konstanz (DE); SOEREN LEMCKE, Gundholzen (DE); STEFAN BOESHAGEN, Kreuzlingen (CH); LUTZ ECKSTEIN, Aachen (DE); CHRISTOPHER BROCKMEIER, Aachen (DE); JOHANNES STEIN, Aachen (DE); MARIUS STAERK, Aachen (DE)

(21) Appl. No.: 16/959,279

(22) PCT Filed: Dec. 20, 2018
(86) PCT No.: PCT/EP2018/086277

§ 371 Date: Jun. 30, 2020

(30) Foreign Application Priority Data
Jan. 5, 2018 (DE) 10 2018 100 194.0

(51) Int. Cl. G06K 9/00; B60R 1/02; B60R 1/12; G06T 7/73

(52) U.S. Cl. CPC G06K 9/00832; B60R 1/02; B60R 2300/101; G06T 7/73; B60R 2001/1253; B60R 1/12

(57) ABSTRACT

A mirror replacement system (12) for a motor vehicle (10) is described, having at least one processor unit (28), an optical sensor unit (14) which generates image and/or video data of the environment of the motor vehicle (10), and a screen (38) which is arranged so as to display at least part of the generated image and/or video data. The mirror replacement system (12) comprises a viewing direction sensor (30) which is arranged so as to determine the viewing direction of the vehicle driver (36) on the screen (38) or the position of the head of the vehicle driver (36). The processor unit (28) is arranged so as to adapt the image and/or video data to be displayed on the screen (38) based on the detected viewing direction or position of the head so that the image and/or video data displayed on the screen (38) are adapted to the position of the head or to the viewing direction of the vehicle driver (36). A method of displaying image and/or video data is furthermore described.

### RELATED APPLICATIONS

This application filed under 35 U.S.0 § 371 is a national phase application of International Application Number PCT/EP2018/086277, filed Dec. 20, 2018, which claims the benefit of German Application No. 10 2018 100 194.0 filed Jan. 5, 2018, the subject matter of which are incorporated herein by reference in their entirety.

### BACKGROUND

The invention relates to a mirror replacement system for a motor vehicle and to a method of displaying image and/or video data of the environment of a motor vehicle by means of a mirror replacement system for a motor vehicle.

Motor vehicles are known from the prior art, which have a mirror replacement system by means of which the conventional physical outside and inside mirrors are replaced by optical sensors and appropriate screens. Three cameras are for example provided, which are each oriented to the rear in the vehicle direction to optically detect the left lateral and rear surroundings, the right lateral arid rear surroundings, and the rear surroundings of the motor vehicle. The image or video data detected by the cameras are then transmitted to a screen, which is provided in a partially translucent inside mirror, for example, in order to be displayed in the inside mirror. This enables the driver to monitor the lateral and rear surroundings of the motor vehicle, as is the case with conventional physical mirrors.

Such a mirror replacement system can therefore replace the conventional physical side and rearview mirrors. If the optical sensors are placed in suitable locations of the vehicle, a better observation of the surroundings of the motor vehicle is even possible, since, among other things, the blind-spot areas occurring with physical mirrors can be monitored more easily.

However, it has been found to be a disadvantage of the mirror replacement systems known from the prior art that they provide a non-intuitive reproduction of the lateral and rear surroundings of the motor vehicle, so that the data or information displayed are sometimes confusing for the vehicle driver.

### SUMMARY

It is the object of the invention to provide a mirror replacement system and a method of displaying image and/or video data by means of which it is possible to produce a natural mirror image which is intuitively comprehensible to the vehicle driver.

According to the invention, the object is achieved by a mirror replacement system for a motor vehicle, having at least one processor unit, an optical sensor unit which generates image and/or video data of the environment of the motor vehicle, and a screen which is arranged so as to display at least part of the generated image and/or video data, the mirror replacement system comprising a viewing direction sensor which is arranged so as to determine the viewing direction of the vehicle driver on the screen or the position of the head of the vehicle driver, i.e. the viewing direction of the vehicle driver on the screen and/or the position of the head of the vehicle driver. The processor unit is arranged so as to adapt the image and/or video data to be displayed on the screen based on the detected viewing direction or the position of the head so that the image and/or video data displayed on the screen are adapted to the position of the head or to the viewing direction of the vehicle driver.

According to the invention, the object is further achieved by a method of displaying image and/or video data of the environment of a motor vehicle by means of a mirror replacement system for a motor vehicle, comprising the following steps:
recording image and/or video data by means of an optical sensor unit,
detecting the viewing direction of the vehicle driver on a screen or the position of the head of the vehicle driver,
processing the recorded image and/or video data by means of a processor unit,
showing at least part he generated image and/or video data by means of the screen,
wherein the viewing direction of the vehicle driver on the screen or the position of the head of the vehicle driver is used in the processing of the recorded image and/or video data, so that the image and/or video data displayed on the screen are adapted to the position of the head or to the viewing direction of the vehicle driver.

A position of the eyes of the vehicle driver can serve to determine the viewing direction of the driver.

The basic idea of the invention is that an image or video is shown on the screen, which corresponds to the mirror image of a physical mirror. For this purpose, the viewing direction of the vehicle driver or the position of the head of the vehicle driver is taken into account to create the mirror image on the screen, which is perceived as being substantially natural and corresponds to that of a real optical mirror image. This means that, depending on the position of the head or on the viewing direction, a different section of the captured image and/or video data of the environment of the motor vehicle can be displayed in order to show a substantially natural mirror image. If the vehicle driver changes his head position or viewing direction, the image or video displayed on the screen will also change, so that the image or video displayed is not perceived as static or rigid. Rather, an interactive and intuitive operation of the mirror replacement system is obtained, as the vehicle driver can accordingly control the displayed information via his head position or viewing direction.

For example, the viewing direction of the vehicle driver is determined by means of suitable image analysis methods, such as so-called eye-tracking methods.

Since the viewing direction of the vehicle driver or the position of the head of the vehicle driver is detected, the mirror replacement system can be configured so as to be automatically self-adjusting.

This means that the mirror replacement system automatically adapts to the size of the vehicle driver by determining the size indirectly via the viewing direction or the position of the head of the vehicle driver. It is therefore no longer necessary to adjust the individual mirrors.

One aspect provides that the optical sensor unit comprises at least one camera, in particular three cameras. The at least one camera can be a wide-angle camera, which accordingly covers a large angular range to provide a wide-angle image. This permits a wide detection of the environment of the motor vehicle, in particular the blind-spot area, which is difficult to detect with a conventional mirror system.

More than three cameras may also be provided, for example four cameras. Two of the four cameras can be assigned to the rear end of the motor vehicle.

Furthermore, the optical sensor unit may also include radar, infrared, laser sensors or other sensors that are suitable for (additionally) monitoring the surroundings of the motor vehicle. Such sensors are advantageous in particular in poor lighting conditions or at night.

According to one embodiment, the optical sensor unit comprises three cameras covering the left lateral (and rear) environment, the right lateral (and rear) environment and the rear environment of the motor vehicle. In this respect, the images or video recorded by the three cameras include at least the information obtained via a conventional mirror system. To this end, two of the three cameras may be located in the area of the sides of the motor vehicle, for example in the areas of the physical side mirrors. Due to the cameras that are assigned to the sides of the motor vehicle, the physical side mirrors can even be omitted.

The third camera can be assigned to the rear end of the vehicle, for example in the bumper or in the roof area, so that it generates rear images.

The processor unit is generally arranged so as to create a coherent image or video from the image and/or video data received separately via the several cameras, which is accordingly displayed on the screen. In this respect, the processor unit receives, for example, from the three cameras a left data set including image or video data assigned to the left side of the motor vehicle, a right data set including image or video data assigned to the right side of the motor vehicle, and a rear data set including image or video data assigned to the rear environment of the motor vehicle. These three data sets are accordingly processed by the processor unit to generate a coherent image/video of the environment of the motor vehicle. This is made possible in particular by the fact that the three cameras each detect overlapping environments, so that the image data or video data are accordingly adapted by the processor unit in the overlap area of the data sets, so that a coherent image or video is produced.

Generally, it may be provided that based on the detected viewing direction or position of the head of the vehicle driver, at least one specific data set is displayed on the screen differently from the remaining data sets. The processor unit is therefore arranged so as to provide at least one specific data set differently from the remaining data sets depending on the detected viewing direction or position of the head of the vehicle driver. This may involve the highlighting of the information of the corresponding data set.

This is for example carried out in addition depending on a selected operating mode, in particular depending on the selected gear.

An interaction of the vehicle driver with the mirror replacement system is therefore possible in that the driver purposefully controls the displayed information based on his movement or change in the viewing direction. For example, in the case of an active reverse gear, a head movement in a specific direction can lead to an assigned data set being highlighted.

A head movement to the front left from the perspective of the vehicle driver can thus lead to an enlarged (in relation to the area of the screen) and/or zoomed display, as a result of which parking is accordingly simplified.

A further aspect is that the viewing direction sensor includes at least one infrared sensor. The infrared sensor ensures that the position of the head or the viewing direction of the vehicle driver can also be detected in darkness, i.e. when driving at night.

In addition, the viewing direction sensor may comprise at least one camera, for example an ROB camera, which is arranged so as to detect the viewing direction of the vehicle driver on the screen or the position of the head of the vehicle driver. The camera may be provided additionally or alternatively to the infrared sensor so that the information from the infrared sensor end the camera is used to detect the viewing direction of the vehicle driver on the screen or the position of the head. The corresponding data can be evaluated additionally.

According to one embodiment, the mirror replacement system is arranged so as to detect the three-dimensional position and/or a change in position of the head of the vehicle driver in all three spatial directions. Similarly, the three-dimensional position and/or a change in position of the head of the vehicle driver is detected in all three spatial directions in the method. In this respect, it is possible to detect a change in the viewing direction, a change in the position of the head or generally the position of the head in the x, y and z direction to produce a mirror image on the screen that is as natural as possible.

In particular, the viewing direction sensor may comprise at least two infrared sensors and/or two cameras to determine the viewing direction of the vehicle driver on the screen or the position of the head of the vehicle driver. This will in particular make it easier to detect the three-dimensional position or the change in position of the head.

The three dimensions x, y, z are for example defined such that the z-direction substantially corresponds to the vehicle direction. Accordingly, the windshield of the motor vehicle is provided substantially in the z-direction opposite the vehicle driver.

The screen can extend in the x-direction and in the y-direction so that the vehicle driver looks at the screen substantially in the z-direction. However, depending on the positioning of the screen, the viewing direction may also include an x and/or y component.

The screen is for example integrated into an inside mirror, which is provided at the position of a conventional physical inside mirror, or is configured as part of an entertainment system, so that the screen can also display entertainment information. The screen may also be a head-up display.

It may also be provided that the screen is positioned in the area of the interior trim, e.g. is integrated there, or is assigned to a corresponding area, for example a sun visor for the vehicle driver, and is in particular integrated in the sun visor.

The mirror replacement system is in particular arranged so as to scale the image and/or video data to be displayed based on a detected change in position of the head in the vehicle direction (z direction), the scaling of the image and/or video data to be displayed being linearly related to the change in position of the head.

The image and/or video data to be displayed are scaled linearly based on a detected change in position of the head in the vehicle direction (z-direction), a scaling factor between 0.0005 and 0.002 per cm being in particular used, for example a scaling factor of 0.00125 per cm. The change in position of the head is for example measured on the basis of a neutral head position of the vehicle driver. A neutral head position of the vehicle driver is to be understood as the position of the head during normal driving.

In order to determine the neutral head position, the position of the head of the vehicle driver can be detected by a suitable sensor, and the position in which the head of the vehicle driver is located for more than 50% of the driving time can in particular be defined as the neutral head position.

In order to avoid a new determination of the neutral head position for each journey, a user profile can be stored in which the neutral head position of the vehicle driver is stored.

The neutral head position can also be constantly checked and updated so that it is constantly adjusted. This is stored in the corresponding user or driver profile.

It is thus possible that the movement of the head of the vehicle driver forwards or backwards, i.e. as seen in the vehicle direction, can lead to a zooming in or out of the displayed information. Due to the linear translation of the movement, a naturally perceived mirror image is created, as the movement sensitivity is comparable to that of a real mirror.

The low scaling factor is advantageous as it results in a discreet translation in which the displayed information appears to be natural, in particular when the head position or the viewing direction is changed. Discretization and noise effects can thus also be reduced.

The origin of the z-axis can lie in the plane in which the viewing direction sensor is located, so that the neutral head position of the vehicle driver is away from the origin of the z-axis.

A further aspect provides that the mirror replacement system is arranged so as to determine a scaling based on an origin which deviates from the neutral head position of the vehicle driver in the vehicle direction (z direction), so that a (slightly) zoomed-out view of the displayed image and/or video data on the screen is obtained in the neutral head position, an offset of approximately 0.75 m being in particular provided.

In other words, when the head of the vehicle driver is in the neutral head position, the image and/or video data are for example displayed to the vehicle driver in a reduced size. An offset of 0.75 m in the neutral head position means, for example, that the image and/or video data are displayed to the vehicle driver as if he were 0.75 m further away from a displayed object.

In the method, the scaling is also determined on the basis of an origin which deviates from the neutral head position of the vehicle driver in the vehicle direction, i.e. in the z-direction, so that a slightly zoomed-out view of the displayed image and/or video data on the screen is obtained in the neutral head position, an offset of approximately 0.75 m being in particular provided.

The neutral head position of the vehicle driver is approximately 90 cm from the origin of the z-axis. Based on the selected offset, for example of approximately 0.75 m, it is possible that already in the neutral head position of the vehicle driver, which the vehicle driver normally assumes, a reduced display of the image and/or video data is obtained, which permits a wide-angle display. The vehicle driver therefore receives more information in the neutral position than is the case with a normal physical mirror system. It is therefore in particular possible to monitor the so-called blind-spot areas in a correspondingly easy manner.

According to a further aspect, the mirror replacement system is arranged so as to shift the image and/or video data to be displayed based on a detected change in the viewing direction or change in position of the head transversely to the vehicle direction, i.e. in the x-direction and/or y-direction, the shifting of the image and/or video data to be displayed being linearly related to the change in the viewing direction or to the change in position of the head.

The image and/or video data to be displayed are shifted linearly based on a detected change in the viewing direction or a change in position of the head transversely to the vehicle direction, i.e. in the x-direction and/or in the y-direction, a scaling factor between 0.05 and 0.2 per cm of an eye movement being in particular used, for example a scaling factor of 0.1 per cm.

If the vehicle driver changes his gaze or the position of his head in the x-direction or in the y-direction, a shifted image is obtained on the screen, as is the case with a conventional optical mirror system. Based on the linear relationship, a natural sensation is also produced for the vehicle driver.

The low scaling factor is also advantageous here, as it results in a discreet translation in which the displayed information appears to be natural, in particular when the head position or the viewing direction is changed. In addition, discretization effects and noise effects can thus be reduced.

The mirror replacement system is in particular arranged so as to determine a shift factor and/or a zoom factor for the adaptation of the displayed image and/or video data, which are/is dependent on the viewing direction or on the position of the head.

A shift factor and/or a zoom factor for the image and/or video data to be displayed are/is determined, which depend(s) on the viewing direction or on the position of the head.

The shift factor or zoom factor is used to convert the detected change in the viewing angle or in the position of the head into a change in the displayed image and/or video data. This means that the image or video to be displayed is changed by the shift factor or the zoom factor if the position of the head or the viewing direction in the x, y or z direction changes accordingly.

In particular, the processor unit is arranged so as to smooth the shift factor and/or the zoom factor exponentially. In the method, the shift factor and/or the zoom factor are smoothed exponentially. A noise of the displayed images as well as jumps in the image or video information are thus avoided, as the corresponding input data are first smoothed. However, as the displayed image and/or video data must be quickly adapted to corresponding movements of the vehicle driver, an exponential smoothing of the shift factor and/or of the zoom factor is provided.

For example, the corresponding actual values of the shift factor or zoom factor are updated on the basis of their set points in each frame, in particular 60 times per second.

Basically, the adaptation of the image and/or video data to be displayed on the screen can be assigned to a scaling and/or shifting based on the detected viewing direction or the position of the head. In other words, the image and/or video data to be displayed on the screen can be scaled and/or shifted based on the detected viewing direction or position of the head. The processor unit is thus arranged so as to scale and/or shift the image and/or video data to be displayed on the screen (38) based on the detected viewing direction or position of the head.

According to a further aspect, the processor unit comprises a fragment shader and is arranged so as to determine the image and/or video data to be displayed taking the shift factor and/or the zoom factor into account, in particular wherein the fragment shader additionally takes the smoothed shift factor, the smoothed zoom factor, the height and/or the width of the images or videos to be displayed into account.

In the method, the image and/or video data to be displayed are calculated in a fragment shader taking the shift factor and/or the zoom factor into account, the smoothed shift factor, the smoothed zoom factor, the height and/or the width of the images or videos to be displayed being in particular additionally taken into account.

The fragment shader thus efficiently calculates the texture coordinates of the individual pixels of the images or videos to be displayed, at least the shift factor or the zoom factor being taken into account.

In particular, the previously smoothed shift factor and/or the smoothed zoom factor are taken into account to provide a corresponding low-noise image and/or video.

At the same time, the height or width of the images or video to be displayed can be taken into account to ensure that the displayed image or video is not distorted.

A further aspect provides that the mirror replacement system is arranged so as to use threshold values for the detected change in the viewing direction, position change or position of the head, wherein the processor unit does not change the image and/or video data to be displayed until they are exceeded.

The method uses threshold values for the detected change in the viewing direction, change in position or position of the head, the image and/or video data to be displayed being not changed until they are exceeded.

It is thus ensured that an unsteady image or video on the screen is avoided, which could be the case as small movements of the head or changes in the viewing direction would constantly lead to a changed displayed section of the detected environment. The threshold values are used to specify minimum distances which must first be overcome in terms of amount before a shifting or scaling of the displayed image and/or video is produced on the screen.

Furthermore, the mirror replacement system can be arranged so as to perform non-linear transformations of the generated image and/or video data so that a scaling of the image and/or video data to be displayed is linearly related to the change in the viewing direction, position change or position of the head. The movement in the vehicle direction (z-direction), which is to be linearly translated, must therefore be correspondingly transformed in a non-linear manner based on the opening angle of the corresponding camera of the optical sensor unit.

### BRIEF DESCRIPTION OF THE DRAWINGS

Further advantages and characteristics of the mirror replacement system according to the invention and of the method according to the invention of displaying image and/or video data of the environment of a motor vehicle will become apparent from the description below and from the drawings to which reference is made and in which:

FIG. 1 shows a schematic representation of a motor vehicle comprising a mirror replacement system according to the invention,

FIG. 2 shows a schematic representation of a mirror replacement system according to one embodiment, and

FIG. 3 shows a schematic representation of a flow chart of a method according to the invention.

### DETAILED DESCRIPTION

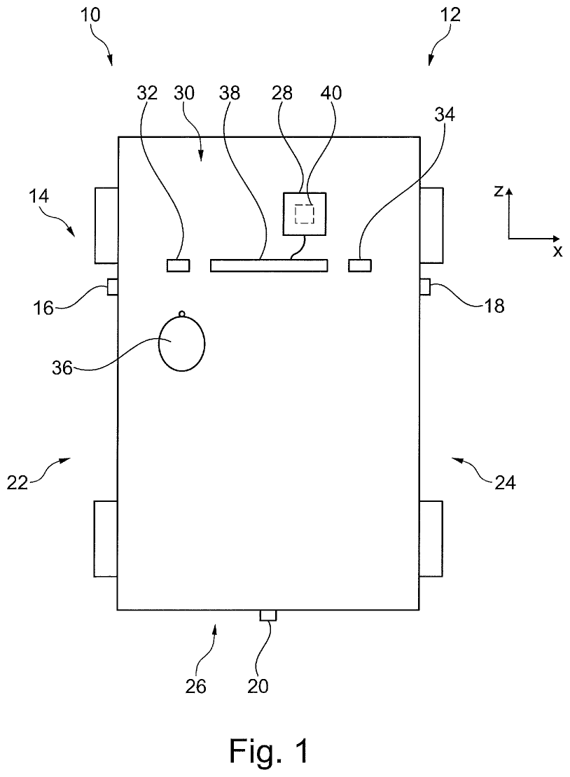

FIG. 1 shows a motor vehicle 10 including a mirror replacement system 12 which replaces a conventional physical mirror system of physical mirrors.

The mirror replacement system 12 has an optical sensor unit 14, which in the embodiment shown comprises three wide-angle cameras 16-20, which are provided to replace the two side mirrors and the inside mirror.

The first camera 16 is assigned to the left side 22 of the motor vehicle 10, whereas the second camera 18 is assigned to the right side 24 of the motor vehicle 10. Furthermore, the third camera 20 is assigned to the rear side 26 of the motor vehicle 10. The respective cameras 16-20 are for example positioned on the respective sides 22-26 of the motor vehicle 10. Therefore, the first camera 16 detects the left lateral and rear environment of the motor vehicle 10, whereas the second camera 18 detects the right lateral and rear environment of the motor vehicle 10. In contrast thereto, the third camera 20 detects the rear area of the motor vehicle 10, in particular the area directly behind the rear end of the motor vehicle 10.

The three cameras 16-20 each detect an area of the environment of the motor vehicle 10, the corresponding areas of the left and right cameras 16, 18 at least partially overlapping with the area of the rear camera 20, so that there is a left overlap area and a right overlap area. Data from two cameras 16-20 are thus detected simultaneously in the respective overlap area.

The image and/or video data of the environment of the motor vehicle 10 detected by the cameras 16-20, i.e. the optical sensor unit 14, are transmitted to a processor unit 28, which is part of the mirror replacement system 12. The processor unit 28 processes the received data accordingly, as explained below.

In addition, the mirror replacement system 12 comprises a viewing direction sensor 30, which in the embodiment shown is formed by two infrared sensors 32, 34, which are located in the vehicle interior.

Alternatively or in addition, the viewing direction sensor 30 can comprise at least one camera, for example an ROB camera, which is directed towards the vehicle driver.

The viewing direction sensor 30 is generally arranged so as to detect the position of the head of the vehicle driver 36 or the viewing direction of the vehicle driver 36 on a screen 38, which is also part of the mirror replacement system 12. Eye-tracking techniques can be used for this purpose.

The image and/or video data detected or generated by the optical sensor unit 14 are displayed on the screen 38, which is why the screen 38 is coupled to the processor unit 28. The detected image or video data are thus shown to the vehicle driver, enabling him to monitor the environment of the motor vehicle 10.

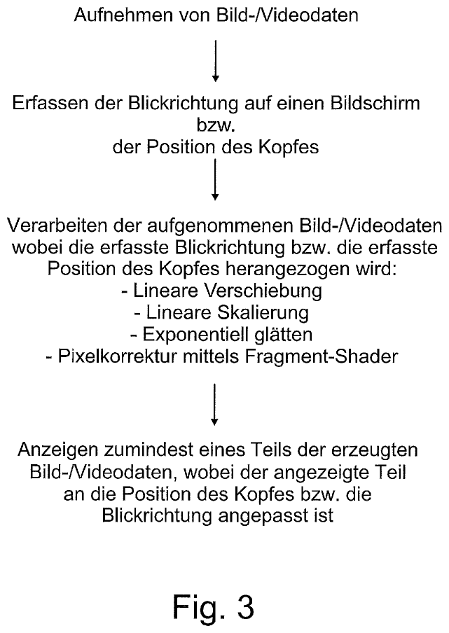

The viewing direction sensor 30 is also coupled to the processor unit 28 so that the data detected by the viewing direction sensor 30 are evaluated and accordingly taken into account by the processor unit 28. This will be explained in more detail below with reference to FIG. 3, when the method of displaying image and/or video data of the environment of the motor vehicle 10 by means of the mirror replacement system 12 is described.

FIG. 1 also shows that the screen 38 is positioned centrally between the two infrared sensors 32, 34.

Generally, the two infrared sensors 32, 34 have a defined distance to each other and to the head of the vehicle driver; at least in the neutral head position.

The screen 38 is also located in a plane which extends in the x and y direction, i.e. transversely to the vehicle direction, as is usually the case with an inside mirror or a dashboard. In this respect, the z-direction is the vehicle direction of the motor vehicle 10. The vehicle direction also substantially corresponds to the direction of travel of the motor vehicle 10.

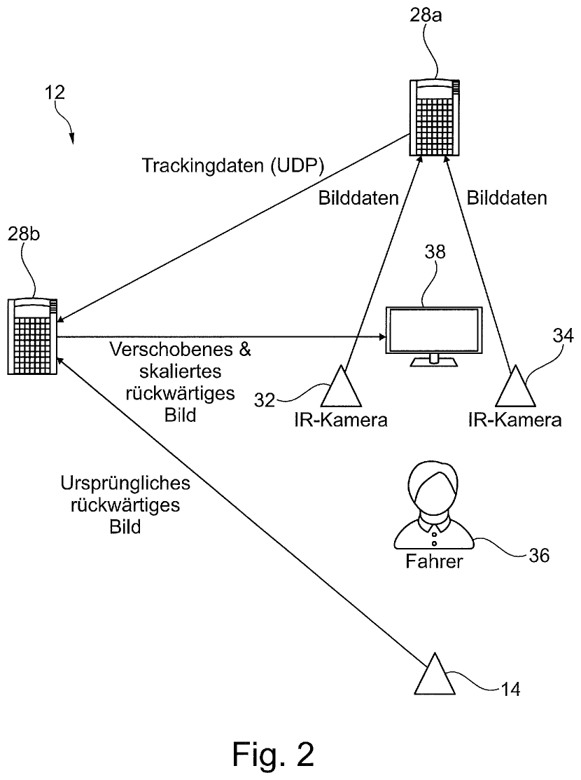

FIG. 2 shows an alternative embodiment of the mirror replacement system 12, which comprises two processor units 28a, 28b. The first processor unit serves to calculate the viewing direction of the vehicle driver or the position of the head of the vehicle driver 36, the correspondingly calculated tracking data being transmitted to the second processor unit 28b, which additionally receives the data detected by the optical sensor unit 14, in particular the corresponding raw data, Based on the tracking data received from the first processor unit 28a and the data received from the optical sensor unit 14, the second processor unit 28b calculates the image to be displayed correspondingly, which is then transmitted to the screen 38 for display.

In this respect, the second embodiment of the mirror replacement system 12 shown in FIG. 2 differs from the first embodiment shown in FIG. 1 only in that two separate processor units 28a, 28b are provided, as a result of which the respective processor units 28a, 28b can be better adapted to the specific requirements, i.e. to the calculation steps to be performed.

With reference to FIG. 3, it is explained below how the mirror replacement system 12 calculates and accordingly displays the image and/or video data of the environment of the motor vehicle 10 to be displayed.

First, image and/or video data of the environment of the motor vehicle 10 are recorded by means of the optical sensor unit 14, i.e. the respective cameras 16 20. This results in a left data set of the first camera 16, a right data set of he second camera 18 and a middle or rear data set of the rear camera 20.

The correspondingly recorded image and/or video data, i.e. the respective data sets, are transmitted to the at least one processor unit 28, where they are further processed.

In addition, the viewing direction of the vehicle driver 36 on the screen 38 or the position of the head of the vehicle driver 36 is detected by means of the viewing direction sensor 30. The three-dimensional position of the head can be detected so that the position in the x, y and z directions, i.e. in the vehicle direction (z direction) and transversely to the vehicle direction (x direction and/or y direction) is determined.

The corresponding data of the viewing direction sensor 30 are forwarded to the at least one processor unit 28, which processes the recorded image and/or video data of the optical sensor unit 14 accordingly. The processor unit 28 also determines the viewing direction of the vehicle driver on the screen 28 or the (three-dimensional) position of the head of the vehicle driver 36 on the basis of the acquired data of the viewing direction sensor 30.

When processing the recorded image and/or video data which are to be displayed, the processor unit 28 uses the determined viewing direction of the vehicle driver on the screen 28 or the (three-dimensional) position of the head of the vehicle driver 36 in order to accordingly adapt the section to be displayed.

On the basis of the detected position of the head of the vehicle driver 36 or his viewing direction, the section to be displayed on the screen 38 is selected accordingly such that the latter is adapted to the position of the head or to the viewing direction of the vehicle driver 36. The generation of a natural or naturally perceived mirror image for the driver 36 on the screen 38 is thus obtained, which depends on the viewing direction or on the position of the head of the vehicle driver 36 and in particular changes or accordingly adapts variably with a change in position or in the viewing direction.

That is to say, if the vehicle driver 36 moves his head or changes the viewing direction, this is detected by the viewing direction sensor 30 and the processor unit 28, so that the section shown on the screen 38 is adapted accordingly. The corresponding change in position of the head is detected in all three spatial directions to create a natural and intuitive mirror image for the vehicle driver 36.

The mirror replacement system 12, in particular the processor unit 28, is arranged so as to linearly scale the image and/or video data to be displayed on the basis of the detected change in position of the head in the z direction, i.e. in the vehicle direction. This results in a particularly natural sensation for the vehicle driver.

A scaling factor between 0.0005 and 0.002 per cm is for example used, in particular a scaling factor of 0.00125 per cm, to calculate a corresponding scaling of the image and/or video data when the vehicle driver 36 moves towards or away from the screen 38 in the vehicle direction.

Furthermore, the mirror replacement system 12, in particular the processor unit 28, can be arranged so as to determine the scaling starting from an origin which deviates from the neutral head position of the vehicle driver 36 in the z-direction, i.e. in the vehicle direction, so that a slightly zoomed-out view of the displayed image and/or video data is obtained on the screen 38 when the vehicle driver 36 is in his neutral seating position, which is associated with the neutral head position.

Generally, a zoom factor is thus determined via which the movement of the head of the vehicle driver 36 in the z-direction, i.e. in the direction of the vehicle, is converted accordingly. The conversion is linear, an offset being provided so that a zoomed-out view is obtained when the driver 36 is in his neutral seating position. The zoom factor can therefore be represented by the following formula:

z′=0.75−0.00125/cm *z

Here, the parameter “z” corresponds to the actual distance of movement of the driver 36 in the z-direction, i.e. in the vehicle direction, which is correspondingly converted with “z′”.

Here, the scaling factor of 0.00125 per cm and the offset of 0.75 are provided so that the origin of the scaling has been moved forward by 0.75 m, the neutral head position being approximately 0.9 m. A shift factor can be calculated in an analogous manner, wherein for this purpose, the processor unit 28 shifts the image and/or video data to be displayed linearly on the basis of a detected change in the viewing direction or change in position of the head in the x-direction and/or y-direction. A scaling factor between 0.05 and 0.2 per cm can be used, for example a scaling factor of 0.1 per cm, so that the following formulae are obtained for the respective shift factors:

x′=0.1/cm*x or y′=0.1/cm*y

The corresponding origin of the x-axis or y-axis is placed in a centered image on the neutral head position of the vehicle driver 36. In the neutral head position, values of 0 are thus obtained.

The calculated shift factors can then be limited to a defined range of values, for example to a range of values from −1 to 1, so that a maximum shifting of the image or video data is obtained.

Generally, the linear shifting or linear scaling of the image and/or video data on the basis of the detected change in position or in the viewing direction ensures that a natural sensation for the vehicle driver is achieved.

At the same time, low translation factors (scaling factors) are used so that confusion of the vehicle driver 36 during the journey is avoided.

In addition, the calculated shift factors and the calculated zoom factor can be smoothed exponentially, so that jumps in the displayed images or videos and noise are avoided. However, since the displayed information must be quickly adapted to incoming movements, an exponential smoothing is advantageous.

To this end, the actual values of the corresponding factor are updated in each frame using the set point of the corresponding factor. Depending on the screen 38 used, this may be the case, for example, 60 times per second, i.e. for a 60 Hz screen. The exponential smoothing can for example be represented by the following formulae:

x″=x″+0.1*(x′−x″),

y″=y″+0.1*(y′−y″) and

z″=z′+0.2*(z′−z″)

The double apostrophized parameters (x″, y″, z″) are the actual values, which are updated accordingly on the basis of their set points (x′, y′, z′).

Furthermore, the processor unit 28 can include a fragment shader 40, which calculates the texture coordinates (u, v) of the individual pixels of the images or videos to be displayed. For this purpose, the fragment shader 40 uses the previously determined shift factors or the zoom factor, in particular the smoothed shift factors or the smoothed zoom factor.

In addition, the fragment shader 40 can take the height (img_height) or width (img_width) of the images or videos to be displayed into account to vary the corresponding texture coordinates (u, v). The fragment shader 40 can then use the following formulae:

u′=img_width−(u*z″ ((1−z″)*0.5)*(1+x″)*img_width) and

v′=v*z″+(1−z″)*0.5*img_height

At the same time, the processor unit 28 can apply thresholds in the generation or processing of the image and/or video data, which are provided for the detected change in the viewing direction, change in position or position of the head, Based on the threshold values, it is ensured that the displayed image and/or video data do not cause an unsettled impression on the vehicle driver 36 because a certain minimum distance must first be exceeded in terms of amount before a change in the displayed image and/or video data, i.e. a shifting or scaling of the image and/or video data occurs.

Furthermore, it may be provided that the processor unit 28 is arranged so as to supplement the image and/or video data provided by the optical sensor unit 14 with information. For example, the information can be maneuver lines which indicate to the driver 36 where the motor vehicle 10 will move based on a selected steering angle when reversing.

Other information that can be displayed for example includes warning signs, symbols and/or highlights.

The additionally displayed information can also be adapted accordingly in terms of its display based on the viewing direction of the vehicle driver 36 or the position of the head, so that not only the image and/or video data acquired by the optical sensor unit 14 is adapted based on the viewing direction or the position of the head of the vehicle driver 36, but also the additionally displayed information.

This creates a natural sensation for a so-caned “augmented reality”, which is similar to a real (physical) mirror.

This therefore results in an intuitively comprehensible mirror replacement system 12, which provides a natural representation of the detected environment of the motor vehicle 10 on the screen 38, as the displayed information accordingly adapts to the viewing direction or the position of the head of the vehicle driver 36.

1. A mirror replacement system (12) for a motor vehicle (10), having at least one processor unit (28), an optical sensor unit (14) which generates image and/or video data of the environment of the motor vehicle (10), and a screen (38) which is arranged so as to display at least part of the generated image and/or video data, wherein the mirror replacement system (12) comprises a viewing direction sensor (30) which is arranged so as to detect the viewing direction of the vehicle driver (36) on the screen (38) or the position of the head of the vehicle driver (36), wherein the processor unit (28) is arranged so as to adapt the image and/or video data to be displayed on the screen (38) based on the detected viewing direction or the position of the head so that the image and/or video data displayed on the screen (38) are adapted to the position of the head or to the viewing direction of the vehicle driver (36).

2. The mirror replacement system (12) according to claim 1, wherein the optical sensor unit (14) comprises at least one camera (16-20), in particular three cameras (16-20).

3. The mirror replacement system (12) according to claim 1, wherein the viewing direction sensor (30) comprises at least one infrared sensor (32, 34).

4. The mirror replacement system (12) according to claim 1, wherein the mirror replacement system (12) is arranged so as to detect the three-dimensional position and/or a change in position of the head of the vehicle driver (36) in all three spatial directions.

5. The mirror replacement system (12) according to claim 1, wherein the mirror replacement system (12) is arranged so as to scale the image and/or video data to be displayed based on a detected change in position of the head in the vehicle direction, the scaling of the image and/or video data to be displayed being linearly related to the change in position of the head.

8. The mirror replacement system (12) according to claim 1, wherein the mirror replacement system (12) is arranged so as to determine a scaling based on an origin which deviates in the vehicle direction from the neutral head position of the vehicle driver (36), so that a zoomed-out view of the displayed image and/or video data on the screen (38) is obtained in the neutral head position, in particular wherein an offset of approximately 0.75 m from the origin is provided.

7. The mirror replacement system (12) according to claim 1, wherein characterized in that the mirror replacement system (12) is arranged so as to shift the image and/or video data to be displayed based on a detected change in the viewing direction or a change in position of the head transversely to the vehicle direction, the shifting of the image and/or video data to be displayed being linearly related to the change in the viewing direction or to the change in position of the head.

8. The mirror replacement system (12) according to claim 1, wherein the mirror replacement system (12) is arranged so as to determine a shift factor and/or a zoom factor for adapting the displayed image and/or video data which is/are dependent on the viewing direction or the position of the head.

9. The mirror replacement system (12) according to claim 8, wherein the processor unit (28) is arranged so as to smooth the shift factor and/or the zoom factor exponentially.

10. The mirror replacement system (12) according to claim 8, wherein the processor unit (28) comprises a fragment shader (40) and is arranged so as to determine the image and/or video data to be displayed taking the shift factor and/or the zoom factor into account, in particular wherein the fragment shader (40) additionally takes the smoothed shift factor, the smoothed zoom factor, the height and/or the width of the images or videos to be displayed into account.

11. The mirror replacement system (12) according to claim 1, wherein the mirror replacement system (12) is arranged so as to use threshold values for the detected change in the viewing direction, the change in position or the position of the head, wherein the processor unit 28 does not change the image and/or video data to be displayed until they are exceeded.

12. The mirror replacement system (12) according to claim 1, wherein the mirror replacement system (12) is arranged so as to carry out non-linear transformations of the generated image and/or video data so that a scaling of the image and/or video data to be displayed is linearly related to the change in the viewing direction, the change in position or the position of the head.

13. A method of displaying image and/or video data of the environment of a motor vehicle (10) by a mirror replacement system (12) for a motor vehicle (10), comprising the following steps:
recording image and/or video data by an optical sensor unit (14),
detecting the viewing direction of the vehicle driver (36) on a screen (38) or the position of the head of the vehicle driver (36),
processing the recorded image and/or video data by a processor unit (28),
showing at least part of the generated image and/or video data by the screen,
wherein
the viewing direction of the vehicle driver (36) on the screen (38) or the position of the head of the vehicle driver (36) is used in the processing of the recorded image and/or video data, so that the image and/or video data displayed on the screen (38) are adapted to the position of the head or to the viewing direction of the vehicle driver (36).

14. The method according to claim 13, wherein the three-dimensional position and/or a change in position of the head of the vehicle driver (36) is/are detected in all three spatial directions.

15. The method according to claim 13, wherein the image and/or video data to be displayed are scaled linearly based on a detected change in position of the head in the vehicle direction, in particular wherein a scaling factor between 0.0005 and 0.002 per cm of a head movement is used, for example a scaling factor of 0.00125 per cm.

16. The method according to claim 13, wherein the image and/or video data to be displayed are shifted linearly based on a detected change in the viewing direction or a change in position of the head transversely to the vehicle direction, in particular wherein a scaling factor between 0.05 and 0.2 per cm of a head movement is used, for example a scaling factor of 0.1 per cm.

17. The method claim 13, wherein the scaling is determined based on an origin which deviates in the vehicle direction from the neutral head position of the vehicle driver (36), so that a slightly zoomed-out view of the displayed image and/or video data on the screen (38) is obtained in the neutral head position, in particular wherein an offset of approximately 0.75 m from the origin is provided.

18. The method according to claim 13, wherein a shift factor and/or a zoom factor is/are determined for the image and/or video data to be displayed, which is/are dependent on the viewing direction or the position of the head.

19. The method according to claim 18, wherein the shift factor and/or the zoom factor are/is smoothed exponentially.

20. The method according to claim 18, wherein the image and/or video data to be displayed are calculated in a fragment shades (40) taking the shift factor and/or the zoom factor into account, in particular wherein in addition, the smoothed shift factor, the smoothed zoom factor, the height and/or the width of the images or videos to be displayed are/is taken into account.

21. The method according to claim 13, wherein threshold values are used for the detected change in the viewing direction, the change in position or the position of the head, the image and/or video data to be displayed being not changed until they are exceeded.
